(19) United States
(12) Patent Application Publication
(10) Pub. No.: US 2004/0181373 A1
(43) Pub. Date: Sep. 16, 2004

(54) Visual simulation of dynamic moving bodies

(75) Inventor: Lawrence M. Lachman, Plano, TX (US)

Correspondence Address: Richard F. Jaworski, Cooper & Dunham LLP, 1185 Avenue of the Americas, New York, NY, 10036, US

(73) Assignee: Computer Associates Think, Inc.

(21) Appl. No.: 10/386,732

(22) Filed: Mar. 12, 2003

(51) Int. Cl. G06F 17/50; G06G 7/48

(52) U.S. Cl. 703/1

(57) ABSTRACT

A method for simulating a dynamic moving body is provided. The dynamic moving body is divided into a plurality of cells. Each cell is associated with a corresponding mesh having an associated resolution. Neighbors of a cell are queried when the cell pages into memory, in order to determine resolutions of respective meshes of the neighbors. The mesh of the cell are adjusted according to a comparison of the resolution of the mesh and the resolutions of the respective meshes of the neighbors.

### TECHNICAL FIELD

The present application relates to computer graphics. In particular, the application relates to visual.simulation of dynamic moving bodies.

### DESCRIPTION OF RELATED ART

Because of the dynamic nature of an ocean scene, ocean water simulation is a computationally expensive computer graphics process and is a difficult task for applications that require visually plausible three-dimensional computer graphics effects at high frame rates.

Fourier synthesis of ocean scenes is a computer graphics technique which enables water surfaces to be decomposed naturally into parts. Through Fourier synthesis techniques, complexity can be adjusted independently and triangulation can be view-dependent. See, for example, G. A. Mastin et al., “Fourier Synthesis of Ocean Scenes”, IEEE Computer Graphics & Applications, p 16-23, (March 1987). However, Fourier synthesis incurs a heavy computational load and therefore is not suitable when real time processing is desired, unless application specific hardware is available.

The concept of levels of detail (LOD) in computer graphics involves rendering geometric meshes of variant polygonal density based on field of view and range from eye point, with a view to optimize CPU utilization ultimately.

Classic geometry LOD optimization techniques either do not perform interactive, real-time adaptive meshing, or do not perform view-dependent adaptive meshing. See, for example, J. H. Clark, “Hierarchical Geometric Models for Visible Surface Algorithms”, Communication of ACM, 19(10):547-554 (October 1976), and T. A. Funkhouser and C. H. Sequin, “Adaptive Display Algorithm for Interactive Frame Rates During Visualization of Complex Virtual Environments”, SIGGRAPH 93 Proceedings, pages 247-254 (1993).

Conventional computer graphics techniques that can interactively perform view-dependent, locally adaptive terrain meshing rely, however, on a pre-defined multi-resolution representation from which to build the adaptive triangle meshes each frame. For example, M. A. Duchaineau et al., ROAMing Terrain: Real-time Optimally Adapting Meshes, IEEE Visualization '97, 81-88 (Nov. 1997) features techniques that maintain view dependent triangle meshes which produce images at a required frame rate. However, these techniques apply to terrain visualization, require preprocessing of the terrain in order to achieve the optimized real-time performance, and require a height map as a reference for the altitude of any point on the map. Since ocean scenes (and other scenes including a dynamic moving body, such as in a computer action game or other simulations involving rapid action or movement) typically have a dynamically changing profile, conventional terrain visualization techniques are not readily adaptable in many instances for simulating the dynamic moving body.

Improved methodologies for simulating a dynamic moving body, such as a body of water or even a dynamic moving body in a scene without any bodies of water, are needed.

### SUMMARY

The present application provides a method for simulating a dynamic moving body. In one embodiment, the method includes dividing the dynamic moving body into a plurality of cells, each cell being associated with a corresponding mesh having an associated resolution, querying neighbors of a cell when the cell pages into memory, in order to determine resolutions of respective meshes of the neighbors, and adjusting the mesh of the cell according to the resolutions of the respective meshes of the neighbors as compared to the resolution of the mesh of the cell.

### BRIEF DESCRIPTION OF THE DRAWINGS

The features of the present application can be more readily understood from the following detailed description with reference to the accompanying drawings wherein:

FIG. 1 shows a flow chart of a method for simulating a dynamic moving body, according to one embodiment of the present application;

FIG. 2A shows a schematic view of a grid structure of 3×2 cells within an exemplary scene including a dynamic moving body;

FIG. 2B shows a cell (1, 0) of the grid structure of FIG. 2A;

FIG. 2C shows a mesh with a resolution of 8×8, co-located in the cell (1, 0) of FIG. 2B;

FIG. 2D shows two meshes with different respective resolutions, including the cell (1, 0) with a mesh resolution of 8×8, and a cell (2, 1) with a mesh resolution of 4×4;

FIG. 2E shows a mesh point in the cell (2, 1) of FIG. 2D;

FIG. 2F shows a mesh facet in the cell (2, 1) of FIG. 2D;

FIGS. 3A and 3B show schematic diagrams illustrating construction of a column of triangles to stitch a mesh to its east neighbor, in which the east neighbor has a higher resolution than the mesh, according to one embodiment of the present disclosure;

FIGS. 4A and 4B show schematic diagrams illustrating construction of a column of triangles to stitch a mesh to its east neighbor, according to another embodiment, in which the east neighbor has a lower resolution than the mesh;

FIGS. 5A and 5B show schematic diagrams illustrating construction of a row of triangles to stitch a mesh to its north neighbor, in which the north neighbor has a higher resolution than the mesh, according to one embodiment;

FIGS. 6A and 6B show schematic diagrams illustrating construction of a row of triangles to stitch a mesh to its north neighbor, according to another embodiment, in which the north neighbor has a lower resolution than the mesh;

FIGS. 7A and 7B show schematic diagrams illustrating stitching of an upper right corner of a mesh to its east and north neighbors, in which the east and north neighbors have higher resolutions than the mesh, according to one embodiment; and

FIGS. 8A and 8B show schematic diagrams illustrating stitching of an upper right corner of a mesh to its east and north neighbors, according to another embodiment, in which the east and north neighbors have lower resolutions than the mesh.

### DETAILED DESCRIPTION

The present disclosure provides tools for simulating a dynamic moving body, including improved methodologies for managing paging of geometry, minimizing memory requirements, selecting levels of detail for cells, selecting levels of detail for triangle geometry, culling cells to the view frustum, and triangle stripping. The tools may be embodied in a computer program (or a module of instructions to which the computer responds) stored on a computer readable medium, such as a compact disc (CD), and/or transmitted via a computer network, such as the Internet, or another transmission medium, such as a wireless medium, in one or more segments.

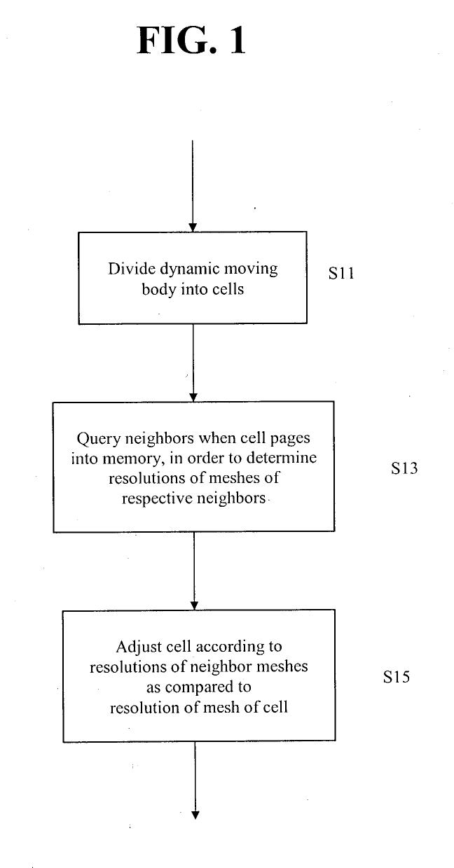

A method for simulating a dynamic moving body, according to one embodiment, will now be explained with reference to FIG. 1. The dynamic moving body is divided into a plurality of cells, with each cell being associated with a corresponding mesh having an associated resolution (step S11). Neighbors of a cell are queried when the cell pages into memory, in order to determine resolutions of respective meshes of the neighbors (step S13). The mesh of the cell are adjusted according to a comparison of the resolution of the mesh and the resolutions of the respective meshes of the neighbors (step S15). The mesh of the cell may be adjusted by constructing one or more strips to stitch together the mesh and the neighbors.

According to one embodiment, the top and right of the mesh of the cell may be adjusted according to a comparison of the resolution of the mesh with resolutions of north and east neighbors, respectively, of the cell. If the resolutions of the mesh and the east neighbor are not the same, one column of triangles may be constructed to stitch together the mesh and the east neighbor. If the resolutions of the mesh and the north neighbor are not the same, one row of triangles is constructed to stitch together the mesh and the north neighbor. When the cell pages out of memory, the cell may reset the east and north neighbors. The cell may also notify west and south neighbors of the cell after the cell pages into memory. When the cell pages out of memory, the cell notifies the west and south neighbors that the cell has paged out.

According to another embodiment, the bottom and left of the mesh of the cell are adjusted according to a comparison of the resolution of the mesh with resolutions of south and west neighbors, respectively, of the cell. If the resolutions of the mesh and the west neighbor are not the same, one column of triangles may be constructed to stitch together the mesh and the west neighbor. If the resolutions of the mesh and a south neighbor are not the same, one row of triangles may be constructed to stitch together the mesh and the south neighbor. When the cell pages out of memory, the cell may reset the west and south neighbors. The cell may also notify east and north neighbors of the cell after the cell pages into memory. When the cell pages out of memory, the cell notifies the east and north neighbors that the cell has paged out.

According to another embodiment, the bottom and right of the mesh of the cell are adjusted according to a comparison of the resolution of the mesh with resolutions of south and east neighbors, respectively, of the cell.

According to another embodiment, the top and left of the mesh of the cell are adjusted according to a comparison of the resolution of the mesh with resolutions of north and west neighbors, respectively, of the cell.

In addition, each cell preferably has a geometry per each one of a plurality of observers.

A master mesh may be computed each frame at a highest resolution amongst the mesh resolutions of the plurality of cells. Positions of vertices in subsequent meshes are sampled from the master mesh.

Each level of detail may be associated with a corresponding maximum linear distance. If a linear distance from an eye point to a cell having a level of detail exceeds the corresponding maximum linear distance, a lower level of detail is selected for the cell.

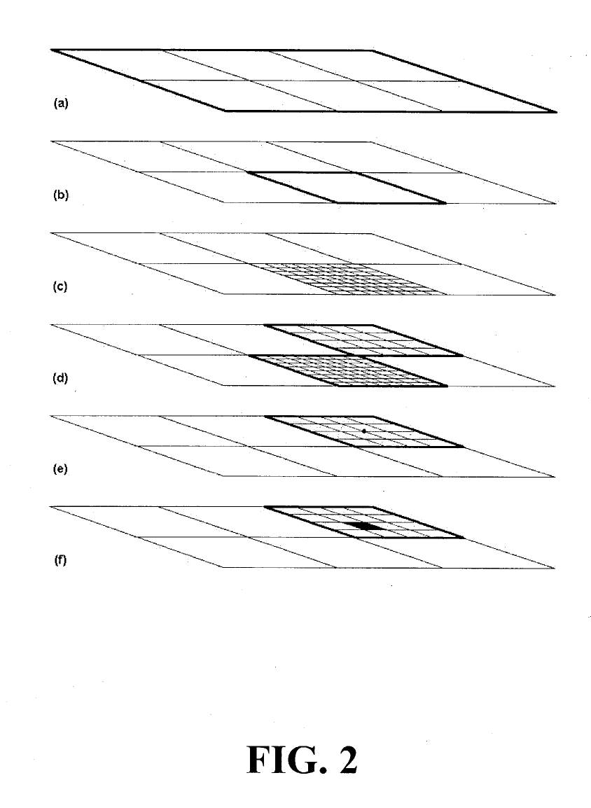

Some terminology is defined below, with reference to FIGS. 2A through 2F, in the context of simulating ocean water. It should be understood that although exemplary embodiments are described herein with reference to an ocean or simulating ocean water, the tools described herein may be applied to simulate other bodies of water and/or other dynamic moving bodies as well.

An ocean (or another dynamic moving body) may be represented as a single level (of detail) rectangular grid of cells. The simulated scene is divided into columns and rows (for example, a grid structure), which define the individual cells of the grid (FIG. 2A). Simulated scenes cover areas larger than a cell by exploiting mesh periodicity.

A cell is a subdivision of the grid structure. A cell is an empty location within the definition of the grid structure. Each cell has a unique pair of column and row numbers (column, row), which is the address of the cell. The cell is independent of the geometry inside of it, and simply identifies the boundaries and address of a location within the grid structure (FIG. 2B). The cell is a physical region of a conceptually large surface in the simulated scene, corresponding to the surface data (for example, geometry) held in a mesh. Fourier synthesis of the scene may optionally be applied to enable cells to be tiled seamlessly over a larger domain.

A mesh is the geometry that occupies a corresponding cell of a grid structure. The mesh is a collection of uniformly spaced, discrete points arranged in a roughly rectangular pattern (FIG. 2C). The points of the mesh correspond to multi-component data elements. Examples of multi-component data elements are height (one dimensional), horizontal position (two dimensional), and normal (three dimensional). Thus, meshes have geometry (for example, positions, heights and/or normals), and exist in a runtime scene graph. While the horizontal dimensions of a mesh are constant throughout the grid, each mesh may have a different resolution (or level of detail) that is a function of range from an actual or virtual observer (FIG. 2D). The data output from mesh objects, such as height, position, and normal, may be associated with both a mesh and a co-located cell. A difference between a mesh and a co-located cell, however, is that a mesh is abstracted from a position on Earth, and a cell is basically a mesh with a location associated with it. Meshes are also seamlessly periodic.

A mesh point is the smallest indivisible element of a mesh (FIG. 2E), and may be referred to in some instances as a “vertex”. Four mesh points comprise a mesh facet (FIG. 2F).

An observer's position affects the level of detail (LOD) and optics of each cell. Regardless of whether an ocean (or another dynamic moving body) is fixed at a specified location, or centered at an observer location, the scene is referenced by an observer at an eye point in the scene, in order for the dynamic moving body to be rendered in the observer's channels (for example, viewports). Each of the channels associated with an observer may share a pointer to the ocean geometry that corresponds to the observer, and therefore the computation does not need to be on a per-channel basis.

In addition, a fixed ocean may be observed by multiple observers. When the ocean's position is fixed and is referenced by one or more observers, it is rendered in each of the observers' channels. While independent of any one observer, with respect to the observer's position, multiple observers present a unique challenge, with respect to the ocean's geometry, that an observer-centered ocean does not encounter, that is, each cell's LOD and optics computations are driven by each observer's unique position.

For example, observer A is on the deck of an aircraft carrier, 40 feet above the surface of the water, while observer B is in an F-18 jet with a view of the entire ocean from 10,000 feet above the surface of the water. The number of cells which fill the horizontal and vertical, field of view of observer A is different from the number for observer B. In addition, the LOD of the cells for observer B requires less fidelity than for observer A.

According to the methodologies of the present disclosure, the per-cell LOD determination, optics computations and vertex list generation occur in the context of an asynchronous paging thread that synchronizes the construction of cell geometry with the main application thread.

While the underlying geometry of each cell that is within range of the eye point is unconditionally computed in the asynchronous paging thread, the cell is not unconditionally rendered. In order for applications to operate at high frame rates, a cell may be view-frustum culled. A view frustum is defined as the intersection of six halfspaces that define the boundaries of what is visible to the eye point. If a cell is not completely or partially within the viewing frustum, then no overhead is incurred to render the cell, and the rendering time may substantially be decreased as a whole.

Each cell is aware of the LOD of its underlying geometry, and may be rendered, at least potentially, in a different level of polygonal detail each frame. The resolution decreases as the cells extend farther out. In order to maintain coherence between meshes, strips are stitched between. neighboring meshes which have different resolutions.

For example, if an east and/or north neighbor cell exists, then the right and/or top of the mesh are stitched correctly to correspond to the resolution of the corresponding neighbor. Otherwise, the right and/or top of the mesh are rendered at the resolution of the cell being examined.

When a cell pages into memory, the cell queries the east and north cell neighbors, if they exist, so the cell can then query their respective LODs each frame, and notifies the west and south neighbors, if they exist, that the cell has just paged in.

Conversely, when a cell pages out of memory, the cell resets its east and north neighbors, and notifies the west and south neighbors, if they exist, that the cell has paged out.

Because the geometry of the ocean (or other dynamic moving body) is generated in an asynchronous thread, and the underlying geometry is unique per observer, a cell contains one mesh per observer, and therefore the cell's LOD and optics may be unique for each observer.

A mesh class encapsulates the underlying geometry of a mesh in the class. The mesh contains data such as the horizontal width on the x-axis, horizontal length on the y-axis, and number of subdivisions of the mesh. The mesh may contain two underlying geometry instances which enable the geometry to be double buffered, with one instance being rendered, while the other is constructed for the next animation sequence.

As discussed further below, the resolution of each mesh is a power of two in both directions (i.e., x and y), meshes are seamlessly periodic, and the horizontal dimensions (i.e., width and length) of all meshes are constant throughout the grid.

The mesh periodicity enables one master ocean mesh to be computed each frame at the highest resolution specified, and subsequent meshes in the scene graph to have the position of their vertices sampled from the master mesh. The sampling of the master mesh enables each mesh in the scene graph to have potentially a different resolution (or level of detail). Vertex-to-world space mapping w(v) is accomplished through w(v)=(vₓ, v_{y}, z(v)) in which (vₓ, v_{y}) are horizontal coordinates of the vertex v (in the master mesh), and z(v) is the height at v.

The mesh knows its level of detail and queries its two neighbors (i.e., to the east/right and to the north/above) to obtain information regarding their respective levels of detail. The mesh may maintain the information regarding the neighbors' levels of detail and uses the information in order to stitch the triangles together between the meshes.

According to one exemplary embodiment, levels of detail are cached as integers in powers of two, (1, 2, 4, . . . ), wherein 1 is associated with the highest detail level (i.e., resolution), in which every vertex is drawn. If the highest resolution of a mesh is 64×64, then a LOD of 1 corresponds to a rendered mesh resolution of 64×64, a LOD of 2 corresponds to a rendered mesh resolution of 32×32, 4 corresponds to a rendered mesh resolution of 16×16, 8 corresponds to a rendered mesh resolution of 8×8, 16 corresponds to a rendered mesh resolution of 4×4, and 32 corresponds to a rendered mesh resolution 2×2.

A mesh having the highest resolution allocates the maximum number of vertices for the LOD. For each frame, the mesh dynamically generates, based on the mesh's LOD and the LODs of the mesh's east and north neighbors, the appropriate number of vertices to fulfill the LOD requirements (for example, no re-allocation of vertex arrays is performed).

The ocean (or other dynamic moving body) can be configured to have a vector of switch distances which may indirectly be associated with the levels of detail. Distances are inserted into the vector in ascending order. Zero is inserted, by default, into the vector when the ocean is constructed. Each adjacent pair of numbers represents a range of distances.

For example, if every value in the vector is a multiple of 100 (up to 500), then there are six ranges in the vector:

[0]=[0-100)

[1]=[100-200)

[2]=[200-300) . . .

[5]=[500-far clip plane)

The value at each index represents the maximum linear distance that the paging strategy can be from the cell for the cell to be rendered at a certain LOD. Above the maximum distance, the cell's LOD complexity is lowered by a power of 2. Cells that are closer to the eye point are triangulated more coarsely than those farther away. The far clip plane is the linear distance from the eye point at which the ocean (or other dynamic moving body) is no longer visible.

The index of each element in the vector corresponds indirectly to the LOD at which the current mesh is rendered when the paging strategy is within the corresponding range. The index corresponds indirectly to the LOD because the index is used as the exponent for computing the base 2 LOD, in which LOD values are a power of 2:

[1, 2, 4, 8, . . . ]=[2⁰, 2¹, 2², 2³, . . . ]

As discussed above, 1 is the highest detail level, in which every vertex is drawn. In the example above, suppose the highest detail level of a mesh is 64×64. Since 64=2⁶, a maximum of six levels of detail ranges may be set. Starting at index zero:

2⁰=1, 2¹=2, 2²=4, 2³=8, 2⁴=16, 2⁵=32.

After the level of detail is determined, the remaining rendering tasks include optimizing the number of triangle strips sent down the rendering pipeline, and maintaining the continuity between meshes of differing resolution, which includes constructing a column of triangles that stitch together the mesh and its east neighbor, a row of triangles that stitch together the mesh and its north neighbor, and a facet in the upper right corner that depends on the resolutions of the neighbors.

Significant performance gains result from organizing triangles into strips. According to one embodiment, the mesh may be rendered as at most four triangle strips. Almost the entire body of the mesh comprises the first strip. The remaining three strips are the right, top, and corner stitchings, respectively.

Each column of triangles may optionally be treated as one triangle strip, and vertex data is generated for each column of triangles. However, in order to optimize the number of commands sent down the rendering pipeline, all of the columns that comprise the body of the mesh are preferably organized into one triangle strip.

The body of the mesh may be constructed in the following manner. Starting at the top left corner of the mesh (0, ymax), the triangles are drawn down to vertex (0, 0). The next column is then processed, starting at (1, ymax). After all of the columns are processed, the last vertex generated is the bottom right corner (xmax, 0). xmax and ymax represent the maximum resolution of the mesh (less a multiple of the LOD value of the mesh). The subtraction of the multiple of the LOD value enables the construction of the rightmost column and topmost row of triangles to be performed in separate steps. The additional column and row of triangles connects the mesh to its neighbors.

In order to stitch the meshes together, each mesh obtains and/or maintains knowledge of its neighbor's LOD. Further, the triangles are preferably constructed in a consistent orientation, such as resulting in front-facing triangles. According to some conventional graphics software, polygons whose vertices appear in counterclockwise order on the screen are so-called “front-facing”. Above the water surface none of the back-facing polygons are sent down the rendering pipeline, and therefore the back-facing polygons are not visible.

Stitching the mesh to its neighbors may include performing the following tasks.

The resolutions of the mesh and its east neighbor are compared. If the resolutions of the mesh and its east neighbor are the same, no adjustive actions need be taken. The column of triangles that connects the two meshes is generated at the same resolution, and is added to the first triangle strip.

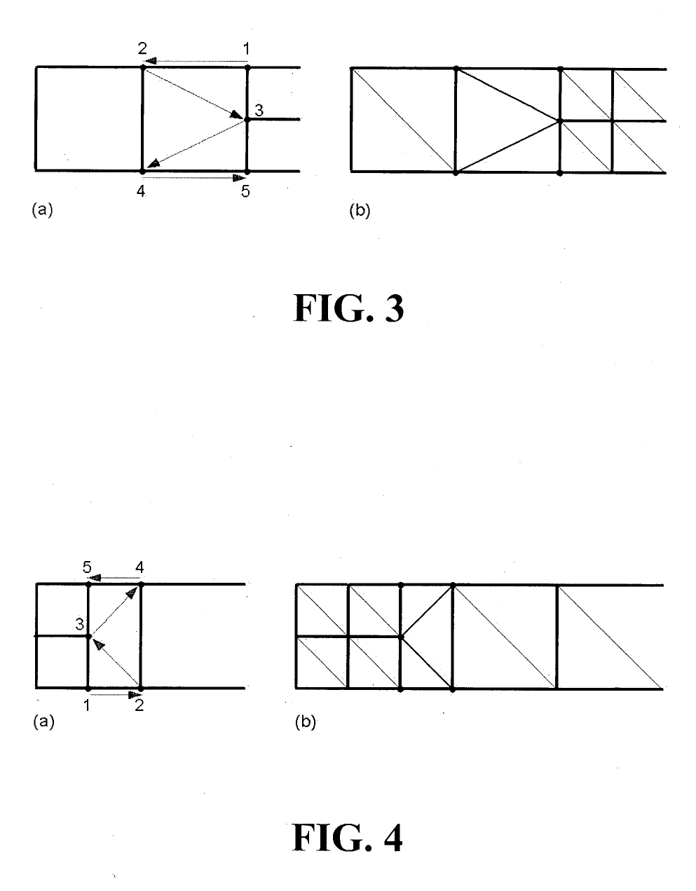

If the mesh to the right (i.e., the east neighbor) is at a higher resolution, then the last column of triangles may be constructed as follows. Starting at the top of the mesh, construct the triangle strip in a repeating pattern, as shown in FIGS. 3A and 3B. Vertices (1 through 5) are visited in the order shown in FIG. 3A. As the column of triangles is constructed, the next facet repeats the pattern, i.e., vertices 5 and 4 become vertices 1 and 2, respectively, for the next facet. FIG. 3B shows one facet that stitches together a low-resolution mesh to the high-resolution mesh of its east neighbor, as rendered.

The triangle to the right of, and adjacent to, the diagonal of the upper right corner is not constructed until the right corner is stitched in later, because construction of the facet depends on the LOD of the north neighbor as well.

If the mesh of the east neighbor is at a lower resolution, then the last column of triangles may be constructed as follows. Starting at the bottom of the mesh, construct the triangle strip in a repeating pattern as shown in FIGS. 4A and 4B. Vertices (1 through 5) are visited in the order shown in FIG. 4A. As the column of triangles is constructed, the next facet above repeats the pattern (i.e., vertices 5 and 4 become vertices 1 and 2, respectively, for the next facet). FIG. 4B shows one facet that stitches together a high-resolution mesh to the low-resolution mesh of the east neighbor, as rendered.

Next, the resolution of the mesh's north neighbor is compared to the mesh's resolution. If the resolutions are the same, no adjustive actions are taken. The row of triangles that connects the two meshes may be generated at the same resolution and added to the first triangle strip.

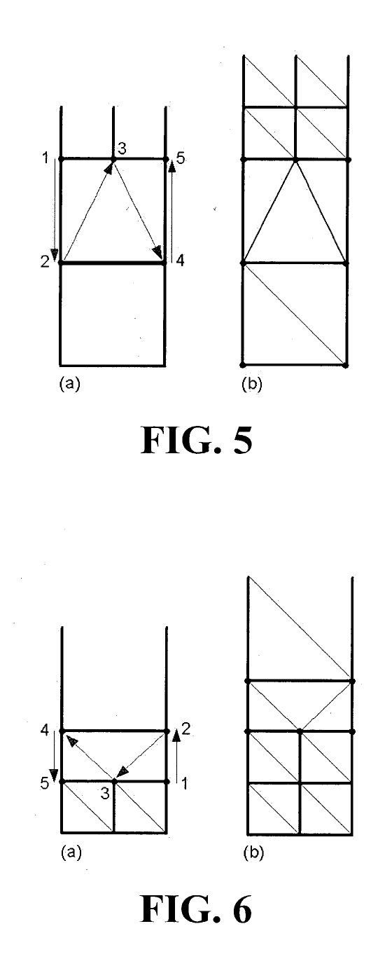

If the mesh above is at a higher resolution, then the top row of triangles is constructed as follows. Starting on the left side of the mesh, construct the triangle strip in a repeating pattern, as shown in FIGS. 5A and 5B. Vertices (1 through 5) are visited in the order shown in FIG. 5A. As the row of triangles is constructed, the next facet to the right repeats the pattern (i.e., vertices 5 and 4 become vertices 1 and 2, respectively, for the next facet). FIG. 5B shows one facet that stitches together a low-resolution mesh to the high-resolution mesh of its north neighbor, as rendered.

If the mesh above is at a lower resolution, then the top row of triangles is constructed as follows. Starting on the right side of the mesh, construct the triangle strip in a repeating pattern, as shown in FIGS. 6A and 6B. Vertices (1 through 5) are visited in the order shown in FIG. 6A. As the row of triangles is constructed, the next facet to the left repeats the pattern (i.e., vertices 5 and 4 become vertices 1 and 2, respectively, for the next facet). FIG. 6B shows one facet that stitches together a high-resolution mesh to the low-resolution mesh of its north neighbor, as rendered.

The triangle to the left of, and adjacent to, the diagonal of the upper right corner is not constructed until the right corner is stitched in later, because construction of the facet depends on the east neighbor as well.

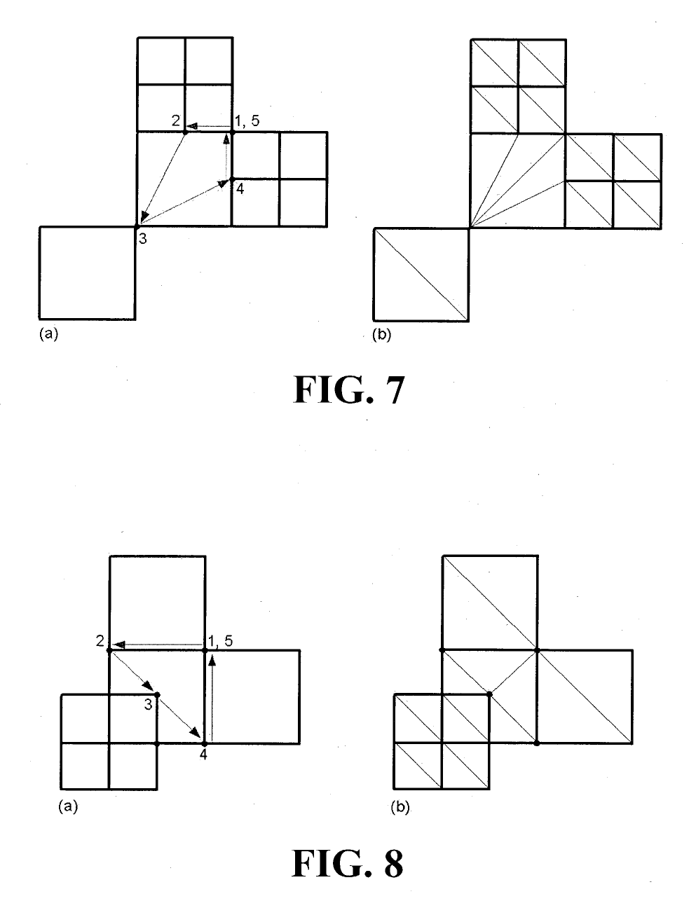

Next, the upper right corner, which is adjacent to both neighbors, is constructed. Regardless of whether the east or north neighbor's resolution is lower or higher, the vertices are visited in the same order. FIGS. 7A, 7B, 8A and 8B illustrate the resulting difference in sampling vertices from the master mesh, based on the LOD of the mesh and the LOD of its two neighbors.

As illustrated in FIG. 7A, both neighboring meshes are at a higher resolution than the current mesh. FIG. 7B shows the corner facet as rendered.

As illustrated in FIG. 8A, both neighboring meshes are at a lower resolution than the current mesh. FIG. 8B shows the corner facet as rendered.

The methodologies of this disclosure produce optimal triangle meshes of varying polygonal density, in which the density is view dependent and the logic may be performed at run-time, does not rely on a pre-defined multi-resolution representation from which to build the adaptive triangle meshes each frame, features optimum triangle stripping, accounts for multiple view-dependent metrics, ensures frame-to-frame coherence while operating at consistent, high frame rates and rendering thousands of triangles per frame, and prevents discontinuities or cracks from appearing between meshes rendered at different resolutions.

Elements and/or features of different illustrative embodiments may be combined with each other and/or substituted for each other within the scope of the present disclosure and appended claims.

The above specific embodiments are illustrative, and many variations can be introduced on these embodiments without departing from the spirit of the disclosure or from the scope of the appended claims.

For example, the representations of levels of detail and how they are translated to resolutions may be different. In addition, the way manner in which the vector of switch distances is cached and processed, and how the values ultimately affect the LOD selection may vary. Further, as should be apparent to one skilled in the art, the underlying geometry of the meshes may be constructed in multiple asynchronous threads.

Although the embodiments described above refer to querying a cell's (or mesh's) east and north neighbors and comparing the resolution of the cell to the resolutions of the east and north neighbors, it should be understood that the query and comparisons may be made with respect alternatively to other equivalent pairs of neighbors, such as the south and the west neighbors, or the south and the east neighbors, or the north and the west neighbors, so long as the selected pair is consistently applied. Thus, reference to the “east neighbor” should be construed to cover the neighbor to the right of the subject cell, or alternatively (and equivalently) the neighbor to the left. Similarly, reference to the “north neighbor” covers the neighbor above the cell, or alternatively (and equivalently) the neighbor below the cell.

What is claimed is:

1. A method for simulating a dynamic moving body, comprising:
dividing the dynamic moving body into a plurality of cells, each cell being associated with a corresponding mesh having an associated resolution;
querying neighbors of a cell when the cell pages into memory, in order to determine resolutions of respective meshes of the neighbors; and
adjusting the mesh of the cell by constructing one or more strips to stitch together the mesh and the neighbors according to a comparison of the resolution of the mesh and the resolutions of the respective meshes of the neighbors.

2. The method of claim 1, wherein the top and right of the mesh of the cell are adjusted according to a comparison of the resolution of the mesh with resolutions of north and east neighbors, respectively, of the cell.

3. The method of claim 2, wherein if the resolutions of the mesh and the east neighbor are not the same, one column of triangles is constructed to stitch together the mesh and the east neighbor.

4. The method of claim 2, wherein if the resolutions of the mesh and the north neighbor are not the same, one row of triangles is constructed to stitch together the mesh and the north neighbor.

5. The method of claim 2, wherein if the resolutions of the north and east neighbors both are higher or both are lower than the resolution of the mesh, a facet is constructed to stitch together the mesh and the north and east neighbors.

6. The method of claim 2, wherein when the cell pages out of memory, the cell resets the east and north neighbors.

7. The method of claim 2, wherein the cell notifies west and south neighbors of the cell after the cell pages into memory.

8. The method of claim 7, wherein when the cell pages out of memory, the cell notifies the west and south neighbors that the cell has paged out.

9. The method of claim 1, wherein the bottom and left of the mesh of the cell are adjusted according to a comparison of the resolution of the mesh with resolutions of south and west neighbors, respectively, of the cell.

10. The method of claim 9, wherein if the resolutions of the mesh and the west neighbor are not the same, one column of triangles is constructed to stitch together the mesh and the west neighbor.

11. The method of claim 9, wherein if the resolutions of the mesh and a south neighbor are not the same, one row of triangles is constructed to stitch together the mesh and the south neighbor.

12. The method of claim 9, wherein if the resolutions of the south and west neighbors both are higher or both are lower than the resolution of the mesh, a facet is constructed to stitch together the mesh and the south and west neighbors.

13. The method of claim 9, wherein when the cell pages out of memory, the cell resets the west and south neighbors.

14. The method of claim 9, wherein the cell notifies east and north neighbors of the cell after the cell pages into memory.

15. The method of claim 14, wherein when the cell pages out of memory, the cell notifies the east and north neighbors that the cell has paged out.

16. The method of claim 1, wherein the bottom and right of the mesh of the cell are adjusted according to a comparison of the resolution of the mesh with resolutions of south and east neighbors, respectively, of the cell.

17. The method of claim 1, wherein the top and left of the mesh of the cell are adjusted according to a comparison of the resolution of the mesh with resolutions of north and west neighbors, respectively, of the cell.

18. The method of claim 1, wherein the cell has a geometry per each one of a plurality of observers.

19. The method of claim 1, wherein a resolution of each mesh is a power of two, and the mesh is seamlessly periodic.

20. The method of claim 1, wherein a master mesh is computed each frame at a highest resolution amongst the mesh resolutions of the plurality of cells.

21. The method of claim 20, wherein positions of vertices in subsequent meshes are sampled from the master mesh.

22. The method of claim 1, wherein a level of detail of each cell has an associated maximum linear distance wherein if a linear distance from an eye point to the cell exceeds the maximum linear distance, a lower level of detail is selected for the cell.

23. The method of claim 1, wherein the dynamic moving body includes a body of water.

24. A program storage device readable by a machine, tangibly embodying a program of instructions executable by the machine to perform the method claimed in claim 1.

25. A computer data signal transmitted in one or more segments in a transmission medium which embodies instructions executable by a computer to perform the method claimed in claim 1.

26. A computer system, comprising:
a processor; and
a program storage device readable by the computer system, tangibly embodying a program of instructions executable by the processor to perform the method claimed in claim 1.
